(19) United States
(12) Patent Application Publication
(10) Pub. No.: US 2003/0222235 A1
(43) Pub. Date: Dec. 4, 2003

(54) Modular shut-off valve apparatus

(76) Inventors: Gregory T. Filkovski, Yorktown, IN (US); Brook W. Pence, Losantville, IN (US)

Correspondence Address: BARNES & THORNBURG, 11 SOUTH MERIDIAN, INDIANAPOLIS, IN, 46204

(21) Appl. No.: 10/162,359

(22) Filed: Jun. 4, 2002

(51) Int. Cl. F16K 31/12

(52) U.S. Cl. 251/30.01

(57) ABSTRACT

A shut-off valve assembly has a main valve module and an electrically-controlled, pneumatically-actuated operator that moves the main valve module between an opened and a closed position. A number of different shut-off valve assemblies are assembled from various components or modules, such as pneumatics modules, switch assemblies, main valve modules, and solenoid valve components. The main valve modules have a variety of sizes and pipe connection styles. In some embodiments, pressurized air is supplied to the pneumatic actuator from pressurized air equipment that is situated in a facility remotely from the shut-off valve apparatus and in other embodiments, an air-delivery module is coupled to the pneumatics module to provide pressurized air to the pneumatic actuator.

### BACKGROUND AND SUMMARY

The present disclosure relates to a shut-off valve apparatus and particularly, to a shut-off valve apparatus having a valve body and an operator that moves a valve in the valve body from a closed position to an opened position to permit material flow through the valve body. The present disclosure also relates to modular shut-off valve apparatus having various modules that couple together to form shut-off valves of different sizes and with different features.

Shut-off valves that open and close to control material flow in a conduit or piping system are known. Some conventional shut-off valves, such as ACTIONAIR® valves available from Maxon Corporation of Muncie, Ind., are electrically controlled, pneumatically actuated valves that are biased mechanically toward a closed position. Because pipes or conduits come in a number of different sizes and styles, shut-off valves are provided by valve manufacturers in a variety of sizes and styles. As a result, valve manufacturers must purchase, store, and assemble numerous shut-off valve components so that shut-off valves having different sizes can be provided to meet customer requirements.

According to the present disclosure, a valve apparatus for use with a source of pressurized air comprises a main valve module having a valve body and a valve member coupled to the valve body. The valve member is movable between a first position blocking material flow through the valve body and a second position permitting material flow through the valve body. The valve apparatus further comprises an operator coupled to the main valve module. The operator has a pneumatics module and an electronics module. The pneumatics module has a pneumatic actuator that, when actuated, moves the valve member from the first position to the second position. The pneumatic actuator is coupled to the source of pressurized air. The pneumatics module has an electrical actuator that, when energized, permits pressurized air from the source of pressurized air to reach the pneumatic actuator to actuate the pneumatic actuator. The electronics module has an electrical connector and at least one conductor that electrically couples the connector to the electrical actuator. The pneumatics module is situated between the electronics module and the main valve module.

In illustrative embodiments, the valve apparatus is configured to couple to pipes of a piping system and the electronics module is configured to decouple from the pneumatics module while the main valve module remains coupled to the pipes of the piping system. The pneumatics module remains coupled to the main valve module when the electronics module is decoupled from the pneumatics module. In addition, the source of pressurized air remains coupled to the pneumatics module when the electronics module is decoupled from the pneumatics module.

According to an aspect of this disclosure, a number of different shutoff valve assemblies are assembled from various components, such as operators, switch assemblies, main valve modules, and solenoid valve components. In addition, main valve modules are available to mate with pipes of different sizes. In some embodiments, pressurized air is supplied to the pneumatic actuator from pressurized air equipment that is situated in a facility remotely from the shut-off valve apparatus and in other embodiments, an air-delivery module is coupled to the pneumatics module to provide pressurized air to the pneumatic actuator.

Additional features will become apparent to those skilled in the art upon consideration of the following detailed description of illustrative embodiments exemplifying the best mode of carrying out the pneumatic exhaust controller as presently perceived.

### BRIEF DESCRIPTION OF THE DRAWINGS

The detailed description particularly refers to the accompanying figures in which:

FIG. 1 is a perspective view of a shut-off valve apparatus according to this disclosure showing the shut-off valve apparatus having a main valve module, a pneumatic actuator module above the main valve module, and an electronics module above the pneumatic actuator module;

FIG. 2 is an exploded perspective view of the shut-off valve apparatus of FIG. 1 showing the electronics module in the lower left corner of the page, a tubular housing of the pneumatic actuator module in the upper right corner of the page, a pneumatic actuator beneath the tubular housing, a pneumatic exhaust controller coupled to a top plate of the pneumatic actuator, and the main valve module beneath the pneumatic actuator;

FIG. 3 is a sectional view of the shut-off valve apparatus of FIG. 1, taken through a vertical central axis of the shut-off valve apparatus, showing a piston of the pneumatic actuator in a raised position and a gate of the main valve module biased by a coil spring upwardly into a closed position blocking a horizontal passage formed in a valve body of the main valve module;

FIG. 4 is a sectional view of the shut-off valve apparatus, similar to FIG. 3, showing pressurized air being introduced through the pneumatic exhaust controller into a top region of a cylinder of the pneumatic actuator, the piston being forced downwardly by receipt of the pressurized air in the top region of the cylinder, the downward movement of the piston compressing the coil spring and moving the gate to an opened position unblocking the horizontal passage formed in the valve body;

FIG. 5 is a diagrammatic view showing five different types of main valve modules grouped in the lower right corner of the page, two different types of operators situated on the left side of the page, four different types of switch assemblies grouped in the upper right corner of the page, and a set of dashed lines indicating that each of the four switch assemblies are usable in an electronics module of each of the operators and indicating that each of the five main valve modules are connectable to a pneumatics module of each of the operators;

FIG. 6 is a perspective view of a pneumatic exhaust controller according to this disclosure, with portions broken away, showing a manifold block, a first portal near a bottom of the manifold block, a second portal (in phantom) near a top of the manifold block, a manifold cap coupled to a top portion of the manifold block, the manifold cap having an exhaust portal, and a solenoid coupled to a lower portion of the manifold block;

FIG. 7 is a part perspective, part diagrammatic view showing a cap and a first solenoid coil detached from a tube of the solenoid of the pneumatic exhaust controller of FIG. 6 and showing a plurality of other solenoid coils that are attachable to the tube of the solenoid in lieu of the first solenoid coil; and

FIG. 8 is a perspective view showing an alternative shut-off valve apparatus, an air-delivery module exploded away from a pneumatics module of the alternative shut-off valve apparatus, and a series of curved dashed lines indicating that the air-delivery module is coupleable to the pneumatic module.

### DETAILED DESCRIPTION OF THE DRAWINGS

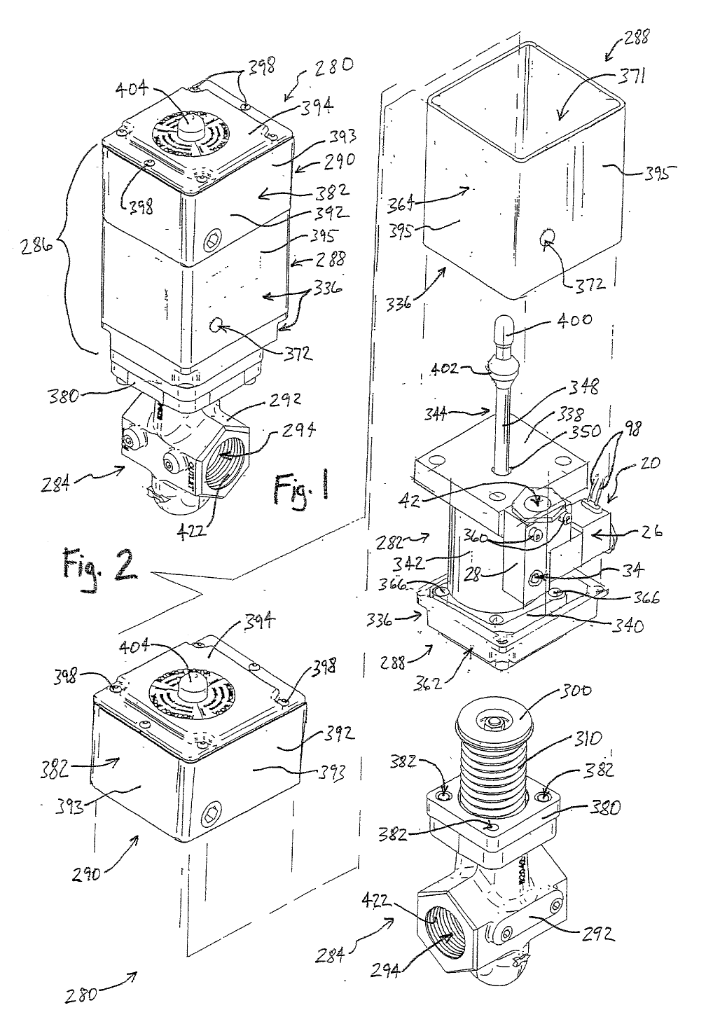

A shut-off valve assembly 280, shown in FIGS. 1-4 has a main valve module 284 and an operator 286 that moves main valve module 284 between opened and closed positions. Operator 286 sets atop module 284 as shown in FIG. 1. Operator 286 comprises a pneumatics module 288 to which module 284 couples and an electronics module 290 situated above module 288. Thus, pneumatics module 288 is situated between electronics module 290 and main valve module 284. Module 288 of operator 286 includes a pneumatic actuator 282 which is actuated by pressurized air. Module 288 of operator 286 further includes a pneumatic exhaust controller 20 that operates to route pressurized air into pneumatic actuator 282 to move module 284 to the opened position and to exhaust pressurized air from pneumatic actuator 282 to move module 284 to the closed position.

Module 284 has a valve body 292 which is formed to include a horizontal passage 294 extending therethrough as shown in FIGS. 1-4. Valve body is also formed to include a vertical passage 295 that extends upwardly from passage 294 as shown in FIGS. 3 and 4. Module 284 further comprises a rod 298 that extends upwardly through passage 295, a gate 296 coupled to a lower portion of rod 298, a disk 300 coupled to an upper portion of rod 298, and a coil spring 310 situated between valve body 292 and disk 300. Rod 298 and gate 296 are movable between a raised position, shown in FIG. 4, in which material is prevented from flowing through passage 294 and a lowered position, shown in FIG. 4, in which material is permitted to flow through passage 294. The word “material” in this disclosure is intended to cover all types of gases, liquids, and solid materials, including granular materials, as well as combinations of these, that are capable of flowing through a passage. Spring 310 serves as a biaser that biases rod 298 and gate 296 to toward the raised position.

Gate 296 is a plate-like element having an opening 312 extending therethrough as shown in FIGS. 3 and 4. When gate 296 is in the lowered position, shown in FIG. 4, opening 312 is aligned with passage 294 and a blocking portion of gate 296, which is the portion of gate 296 beneath opening 312, is received in a chamber 314 that is formed in valve body 292 beneath passage 292. When gate 296 is in the raised position, shown in FIG. 3, the blocking portion of gate 296 is situated in passage 294 to block the flow of material through passage 294.

Illustrative module 284 is sometimes referred to as a “gate valve.” In lieu of the illustrative gate valve of FIGS. 1-4, it is within the scope of this disclosure for module 284 of shut-off valve assembly 280 to be configured as a ball valve, a flapper valve, a needle valve, a plug valve, or any other suitable type of valve capable of moving to open and close passage 294 or a similar passage of appropriate configuration.

The lower portion of rod 298 is slotted and the upper portion of gate 296 is received in the slot of rod 298 as shown in FIGS. 3 and 4. Gate 296 is coupled to the lower portion of rod 298 by a pin 322 that extends through the lower portion of rod 298 and through the upper portion of gate 296. Illustrative module 284 has a first valve ring 316 situated in passage 294 on one side of gate 296 and a second valve ring 318 situated in passage 294 on the other side of gate 296. A wavy washer or spring 320 is compressed between a first shoulder 324 of valve body 292 and first valve ring 316. Spring 320 acts through ring 316 and through gate 296, which floats axially on pin 322, to bias second valve ring 318 against a second shoulder 326 of valve body 292. Thus, gate 296 is sandwiched between rings 316, 318. Spring 320 imparts a sufficient amount of force on rings 316, 318 and gate 296 so that rings 316, 318 sealingly engage gate 296. An o-ring 328 is provided at the interface between an outer periphery of ring 318 and valve body 292 to further seal passage 294 when gate 296 is in the raised position. In alternative embodiments, a rotary coupling, such as a spherical bearing or a ball-and-socket joint, joins rod 298 and gate 296 in lieu of the illustrative pin and slot arrangement.

Valve body 292 has a cylindrical wall 330 that surrounds and defines an upper portion of passage 295 as shown in FIGS. 3 and 4. Cylindrical wall 330 extends upwardly into an interior region of coil spring 310 and terminates at an upwardly facing surface 332 as shown best in FIG. 3. Rod 298 extends from gate 296 upwardly through cylindrical wall 220 and supports disk 300 above surface 332. When rod 298 and gate 296 are in the raised position, disk 300 is spaced apart from surface 332. When rod 298 and gate 296 are in the lowered position, disk 300 engages surface 332. Thus, surface 332 of cylindrical wall 330 serves as a stop that limits the amount of downward movement of disk 300, rod 298, and gate 296. A pair of o-rings 334 are coupled to valve body 292 and engage an outer surface of rod 298 to pneumatically seal the portion of passage 295 above 0-rings 334 from the portion of passage 295 below o-rings 334.

Pneumatics module 288 comprises pneumatic actuator 282, controller 20, and a housing 336 as shown in FIGS. 1-4. Illustrative pneumatic actuator 282 has a top plate 338, a bottom plate 340, and a cylindrical wall 342 extending vertically between plates 338, 340. Actuator 282 further comprises a piston 344 having a piston head 346 situated between plates 338, 340 in an interior region of cylindrical wall 342 and a piston rod 348 extending upwardly from piston head 346 through an opening 350 formed in top plate 338 as shown in FIGS. 3 and 4. Actuator 282 also has a first seal 352, which is coupled to top plate 338 and which engages an outer surface of piston rod 348, and a second seal 354, which is coupled to piston head 346 and which engages an inner surface of cylindrical wall 342. In one embodiment, actuator 282 is a pneumatic actuator available from, for example, Bimba Manufacturing Company of Monee, Ill. Suitable pneumatic actuators are available from other manufacturers as well.

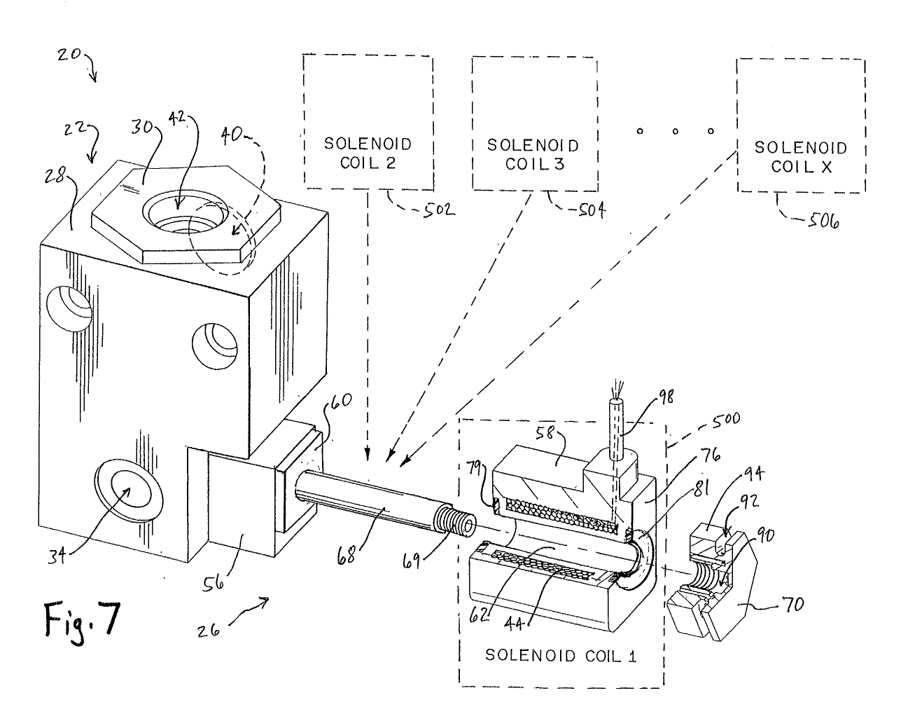

Actuator 282 includes a controller 20, which is coupled to top plate 338 with suitable couplers, such as illustrative bolts 360. As shown in FIGS. 6 and 7, controller 20 has a manifold 22 including a manifold block 28 and a manifold cap 30. Block 28 is formed to include a first portal 34, shown in FIGS. 6 and 7 (in solid) and a second portal 40, shown in FIGS. 6 and 7 (in phantom). Cap 30 is formed to include an exhaust portal 42. A source of pressurized air (not shown) is coupled to first portal 34. Controller 20 has a solenoid 26 coupled to manifold block 22 as shown, for example, in FIG. 2. When solenoid 26 is energized, pressurized air flows from portal 34 to portal 40.

Top plate 338 has a pneumatic passage 356, shown in FIGS. 3 and 4 (in phantom), through which pressurized air flows when either entering or exiting a space 358, shown best in FIG. 4, defined between piston head 346 and top plate 338. Controller 20 is coupled to top plate 338 of actuator 282 so that portal 40 of manifold block 28 of controller 20 is in pneumatic communication with passage 356. Thus, pressurized air exiting manifold block 22 through portal 40 when solenoid 26 is energized, enters space 358 through passage 356 to actuate actuator 282. An o-ring (not shown) or other suitable sealing member, such as a gasket, is provided around portal 40 at the interface between manifold block 22 and plate 338 to provide sealed interface between controller 20 and actuator 282. Such an arrangement eliminates the need for additional components, such as threaded connectors, between portal 40 and passage 356. When solenoid 26 is de-energized, pneumatic communication between portal 34 and portal 40 is blocked and the pressurized air in space 358 flows through portal 40 into manifold block 22 and then exhausts through portal 42.

Housing 336 comprises a bottom piece 362 and a tubular upper piece 364 that couples to bottom piece 336. Bottom plate 340 of actuator 282 couples to bottom piece 362 of housing 336 with suitable couplers, such as bolts 366. The bottom portion of cylindrical wall 342 is received in a large opening defined by a cylindrical surface 368 that extends through bottom plate 340 as shown in FIGS. 3 and 4. Bottom piece 362 of housing 336 has a cylindrical surface 370 that extends therethrough and that is aligned with the interior surface of cylindrical wall 342 of actuator 282. Upper piece 364 of housing 336 is coupled to and extends upwardly from bottom piece 362. Controller 20 and the majority of actuator 282 are situated in an interior region 371 of upper piece 364. In addition, upper piece 364 has an opening 372, shown in FIGS. 1 and 2, that aligns with portal 34 of controller 20. A fitting 374, such as an NPT connector, has a hexagonal portion 376 that abuts piece 364 and a tubular portion 378 that extends from hexagonal portion 376 through opening 372 into pneumatic communication with portal 34. An o-ring (not shown) or other suitable sealing member, such as a gasket, is provided between fitting 374 and manifold block 28.

Valve body 292 has a square-shaped flange 380 that couples to bottom piece 362 of housing 336 with suitable couplers, such as bolts (not shown). Bolt-receiving apertures 382 are formed in the corner regions of flange 380 which permits shut-off valve module 284 to be coupled to pneumatics module 288 in any one of four orientations. For example, one orientation of module 282 relative to module 288 is shown in FIGS. 1, 3, and 4 and another orientation of module 282 relative to module 288 is shown in FIG. 2.

Disk 300, along with portions of rod 298 and spring 310, are received in the interior region of cylindrical wall 342 of actuator 282 beneath piston head 346 as shown in FIGS. 3 and 4. Spring 310 biases disk 300 into contact with piston head 346. In addition, cylindrical wall 330 of valve body 292 extends upwardly through the opening defined by cylindrical surface 370 of piece 362 into the interior region of cylindrical wall 342 of pneumatic actuator 282.

When piston 344 is in a raised position, shown in FIG. 3, and pressurized air is introduced into space 358 through controller 20, piston 344 moves downwardly from the raised position to a lowered position, shown in FIG. 4. As piston 344 moves from the raised position to the lowered position, piston head 346 pushes disk 300, rod 298, and gate 296 downwardly against the bias of spring 310 from the raised position to the lowered position to open shut-off valve module 284. Contact between disk 300 and surface 332 of cylindrical wall 330 limits the amount of downward movement of piston 344 relative to cylindrical wall 342 of actuator 282. Module 284 remains open so long as space 358 is pressurized by an amount that overcomes the bias of spring 310.

When solenoid 26 of controller 20 is de-energized the source of pressurized air is decoupled from space 358. After the source of pressurized air is decoupled from space 358, spring 310 forces disk 300 and piston 344 upwardly which, in turn, forces the air extant in space 358 out of actuator 282, through passage 356, into controller 20 through portal 40, and then out of controller 20 through exhaust portal 42 into the interior region 371 of piece 364. The air in interior region 371 communicates with the ambient environment around assembly 280 through a vertical passage 379 formed in bottom piece 362 of housing 336. A filter 381 is situated in passage 379 as shown in FIGS. 3 and 4. The air in space 358 exhausts rapidly out of actuator 282 through controller 220 when solenoid 26 is de-energized so that shut-off valve module 282 closes quickly.

Electronics module 290 has a housing 382 with an interior region 384 as shown in FIGS. 3 and 4. Electronics module 290 also has a switch assembly 387 situated in interior region 384. Switch assembly 387 comprises a bracket 386 coupled to housing 382 in interior region 384, an electrical connector 388 coupled to bracket 386, and one or more limit switches 390 coupled to bracket 386 as shown in FIGS. 3 and 4. Housing 382 comprises a main body 392, a cover plate 394, and an access plate 396. Cover plate 394 couples to main body 392 with suitable couplers, such as bolts 398, to cover an open top of main body 392. Access plate 396 couples to main body 392 with suitable couplers (not shown) to cover an open side of main body 392. Main body 392 is coupled to the top of upper piece 364 of housing 336 of module 288.

Electronics module 290 fits on top of pneumatics module 288 so that vertical outer surfaces 393 of main body 392 are substantially coplanar with associated vertical outer surfaces 395 of piece 364 of housing 336 that lie thereunder as shown, for example, in FIG. 1. In an alternative embodiment, main body 392 of module 288 and piece 364 of housing 336 are formed as an integral unit. Illustratively, outer surfaces 393, 395 are substantially square-shaped in horizontal cross section. However, it is within in the scope of this disclosure for modules 288, 290 to have other configurations such that the horizontal cross sections of outer surfaces 393, 395 are, for example, circular, elliptical, triangular, rectangular, hexagonal, octagonal, and so on. In addition, it is within the scope of this disclosure for surfaces 393 not to be substantially coplanar with surfaces 395. Thus, housing 336 and housing 382 may be configured in any shape and still be within in the scope of this disclosure so long as modules 288, 290 are able to couple together to form an operator that is capable of moving shut-off valve module 284 between the opened and closed positions.

Access plate 396 is removable from main body 392 so that connector 388 is accessible for coupling with a mating connector (not shown). Electrical signals are communicated to and from shut-off valve assembly 280 through connector 388. For example, connector 388 is coupled electrically via cables 98 to solenoid 26 and electrical signals to energize and de-energize solenoid 26 are communicated to cables 98 through connector 388. Cables 98 are routed from connector 388 through interior region 384 of housing 382 and downwardly into interior region 371 of piece 364. Limit switches 390 are coupled electrically to connector 388 and provide signals indicative of the position of piston 344.

An indicator tip 400 is coupled to the top of piston rod 348 as shown in FIGS. 2-4. Tip 400 has a cam portion 402 that wipes against movable members (not shown) of limit switches 390 to move switches 390 from an OFF state to an ON state. When piston 344 is in the raised position, an upper limit switch 390 is in the ON state and a lower limit switch 390 is the OFF state. When piston 344 is in the lowered position, the upper limit switch 390 is in the OFF state and the lower limit switch 390 is in the ON state. The positions of switches 390 is communicated electrically through connector 388 to valve control equipment, such as, for example, a programmable logic controller.

Cover plate 394 has a cylindrical edge 399 defining an opening in cover plate 394 as shown in FIGS. 3 and 4. Housing 382 of module 290 has a transparent dome 404 that is coupled to cover plate 394 and that extends through the opening defined by edge 399 as also shown in FIGS. 3 and 4. When piston 344 is in the raised position, the upper portion of tip 400 is present in dome 404 and when piston 344 is in the lowered position, the upper portion of tip 400 is absent from dome 404. Thus, the presence or absence of tip 400 in dome 404 provides a visual indication of whether valve module 284 is closed or opened, respectively.

Shut-off valve assembly 280 is well suited for use in industrial environments, such as in piping systems of manufacturing plants, chemical processing plants, petroleum refineries, and the like. Controller 20, along with a majority of actuator 282, is situated in interior region 371 of housing 336 as described above. In addition, switch assembly 387, along with a portion of actuator 282, is situated in interior region 384 of housing 382. Thus, housings 336, 382 protect controller 20, actuator 282, and switch assembly 387 from inadvertent impacts and from the harsh conditions that are oftentimes found in industrial environments. Shut-off valve assembly 280 is configured so that electronics module 290 is removable from pneumatics module 288 without the need to disconnect pneumatic lines that are coupled to fitting 374 to deliver pressurized air to operator 286 and without the need to disconnect pneumatics module 288 from main valve module 284. In addition, shutoff valve assembly 280 is configured so that operator 286 is removable from module 284 without the need to disconnect module 284 from the pipes, conduits, or lines to which module 284 is connected. After removal of operator 286 from module 284, module 284 remains in the closed position.

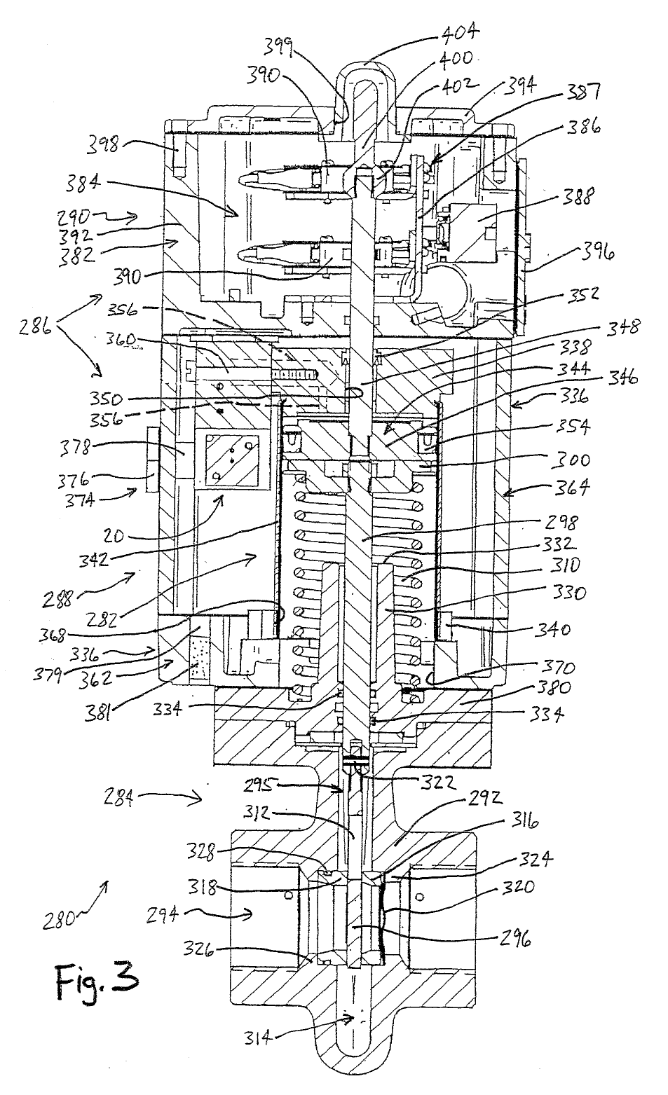

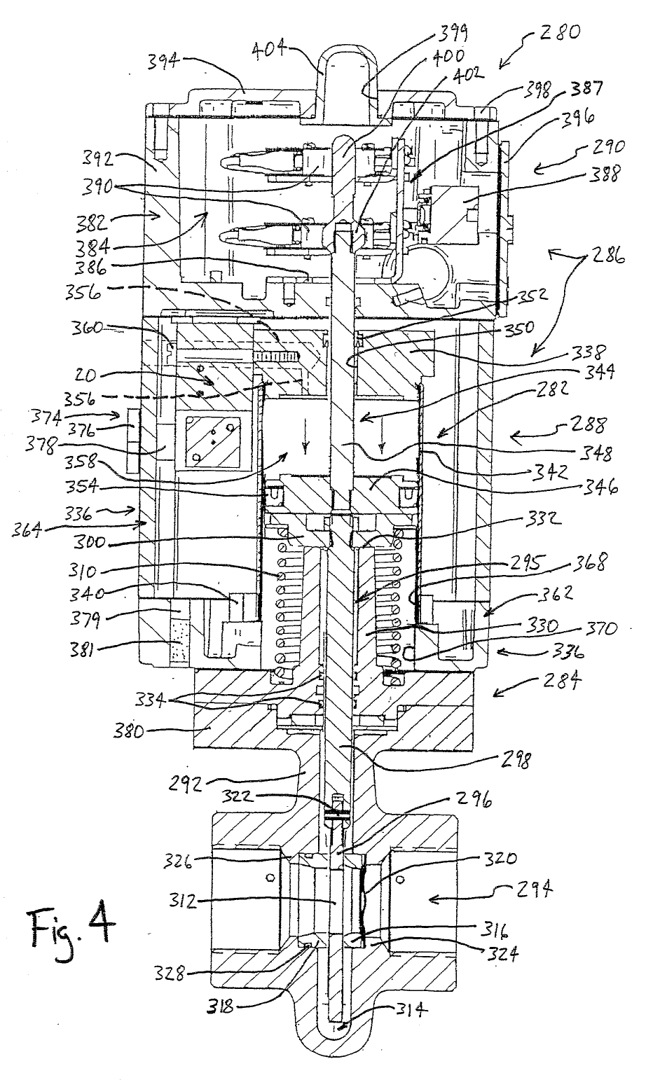

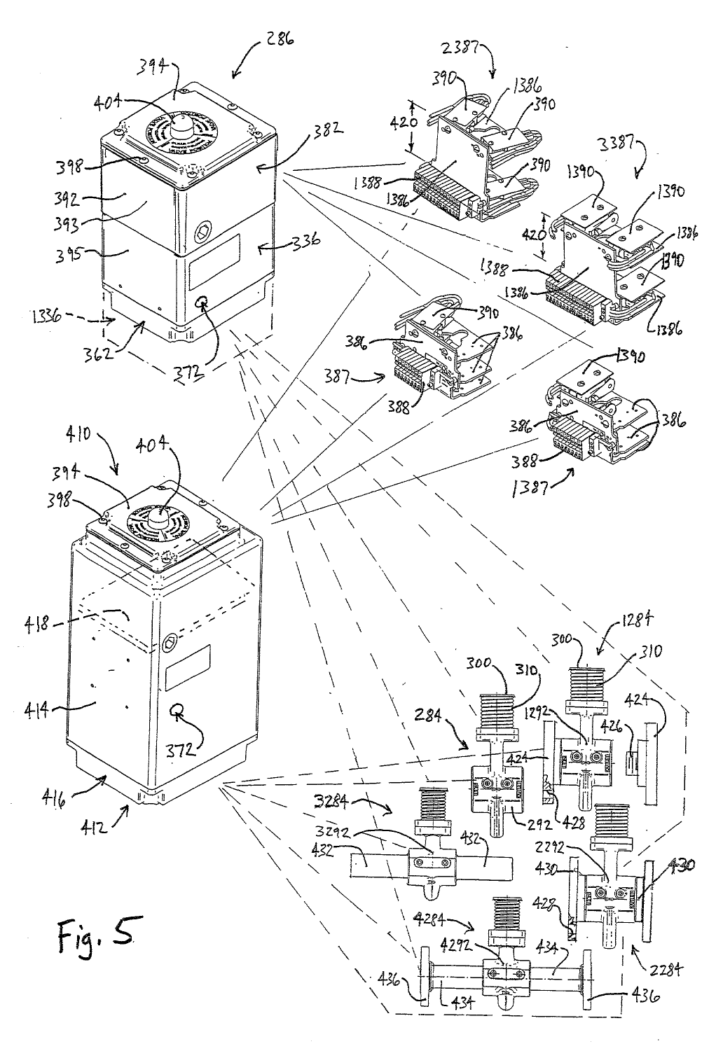

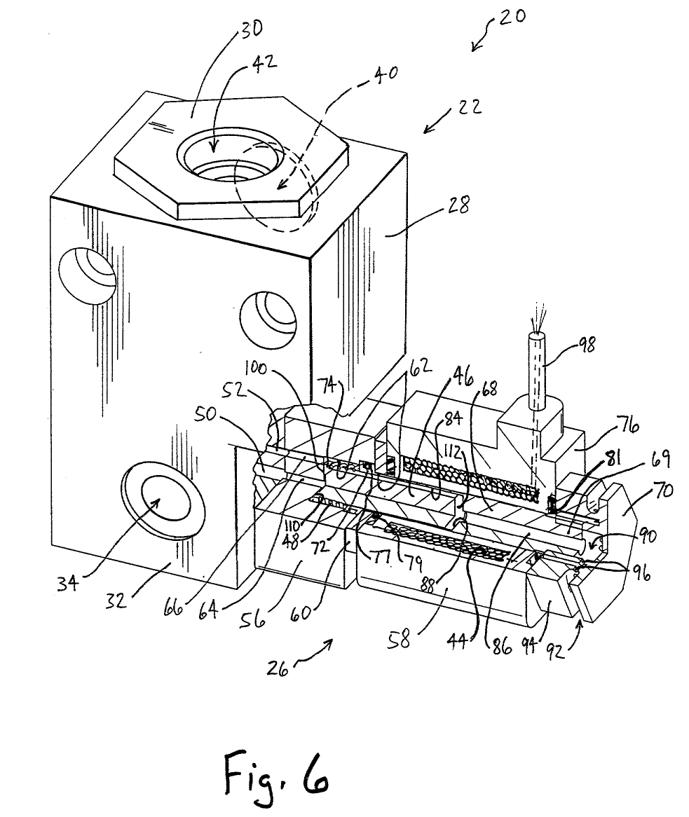

Referring now to FIG. 5, an alternative operator 410 is illustrated beneath operator 286. Operator 410 has a housing 412 which comprises a tubular piece 414, a bottom plate 416 coupled to the bottom of piece 414, and a partition plate 418 (in phantom) that subdivides housing 412 into an upper compartment and a lower compartment. The upper compartment above partition plate 418 is associated with an electronics module portion of operator 410 and the lower compartment below partition plate 418 is associated with a pneumatics module portion of operator 410. Housing 412 also has a cover plate 394, which is sized and configured the same as cover plate 394 of housing 382 of operator 286, and an access plate (not shown), which is sized and configured the same as access plate 396 of operator 286. Operator 410 further comprises a set of fasteners 398 and a dome 404 as was the case with operator 286.

Operator 410 has a pneumatic actuator (not shown) that is similar to actuator 282 of operator 286 but that is slightly larger in diameter and in stroke length. However, operator 410 comprises controller 20 that is coupled to the associated “larger-size” actuator and that operates to direct pressurized air into and exhaust pressurized air from the “larger-size” actuator in the same manner as described above with reference to actuator 286. Thus, piece 414 of housing 412 has an opening 372 through which pressurized air is provided to portal 34 of the associated controller 20.

As shown diagrammatically in FIG. 5, a number of different types of switch assemblies and a number of different types of main valve modules may be used in conjunction with either operator 286 or operator 410. In addition, an operator similar to operator 286, but having a pneumatic actuator with a stoke length longer than operator 286, is used in conjunction with certain switch assemblies and main valve modules. The embodiments having a pneumatic actuator with longer stroke length include a housing 1336, which is similar to, but longer than, housing 336 as shown in FIG. 5 (in phantom). Thus, a “short stroke” operator 286 and a “long stroke” operator 286 are contemplated by this disclosure.

An entire product offering of shut-off valves is created by assembling the various operators, switch assemblies, and main valve modules in various ways. For example, in lieu of switch assembly 387, a switch assembly 1387 may be used in “short stroke” operator 286. A switch assembly 2387 and a switch assembly 3287 may be used either in the “long stroke” operator 286 or in operator 410. In this example, therefore, the stroke length of the pneumatic actuator associated with operator 410 is substantially the same as the stroke length of the pneumatic actuator associated with the “long stroke” operator 286. However, the piston diameters of the “short stroke” and “long stroke” operators 286 are substantially the same, such as for example 2.5 inches (6.35 cm), whereas the piston diameter of operator 410 is larger, such as for example 4 inches (10.16 cm).

A number of different sizes and styles of main valve modules are contemplated by this disclosure. For example, a module 1284 or a module 2284 may be coupled to “short stroke” operator 286 in lieu of module 284. Modules (not shown) similar to modules 284, 1284, 2284, but with certain components such as spring 310, gate 296, and rod 298 being configured with appropriate length, may be coupled to “long stroke” operator 286. In addition, a module 3284 or a module 4284 may be coupled to operator 410. It will be appreciated that the illustrative combinations of main valve modules 284, 1284, 2284, 3284, 4284 and operators 286, 410 are given as examples only and are not exhaustive of all of the sizes and styles of main valve modules that may be combined with operators 286, 410 in accordance with this disclosure. Thus, main valve modules similar to modules 284, 1284, 2284, but appropriately scaled up in size, may be used with operator 410. Similarly, main valve modules similar to modules 3284, 4284, but appropriately scaled down in size and having proper stroke length, may be used with either “short stroke” operator 286 or “long stroke” operator 286.

In some industrial environments where combustible gases or fluids are pumped through piping systems having shut-off valves, certain safety regulations, such as those established by the National Electrical Manufacturers Association (NEMA), require that hermetically sealed switches be used in these shut-off valves. Thus, to comply with these safety regulations, switch assemblies 1387, 3387 have hermetically sealed switches 1390 instead of switches 390. Other applications may call for unsealed, general purpose switches or switches that are sealed to an intermediate level. Use of any and all types of switches in switch assemblies 387, 1387, 2387, 3387, as well as other types of position sensors, such as optical sensors, magnetic sensors, linear variable displacement transducers, and the like, as well as their equivalents, are within the teachings of this disclosure.

In some applications, where an extra degree of certainty as to the whether the shut-off valve assembly is opened or closed, certain safety regulations call for redundant monitoring of the valve position. Thus, to comply with these safety regulations, switch assembly 2387 has a pair of upper switches 390 that are tripped by cam portion 402 when the associated rod and gate of the corresponding actuator are in the raised position (i.e. when the associated main valve module is in the closed position) and a pair of lower switches 390 that are tripped by cam portion 402 when the associated rod and gate of the corresponding actuator are in the lowered position (i.e. when the associated main valve module is in the opened position). Similarly, switch assembly 3387 has a pair of upper switches 1390 and a pair of lower switches 1390 that are tripped by cam portion 402 when the associated rod and gate of the corresponding actuator are in the raise and lowered positions, respectively. In the illustrative embodiments, switches 390, 1390 are the types of switches available from, for example, Honeywell Inc. of Freeport, Illinois. Suitable switches are available from other manufacturers as well.

Because the stroke lengths of the respective pneumatic actuators of the “long stroke” operator 286 and of operator 410 are longer than the stroke length of actuator 282 of “short stroke” operator 286, a vertical distance 420 between the upper and lower switches 390, 1390 of switch assemblies 2387, 3387, respectively, is larger than the vertical distance between the upper and lower switches 390, 1390 of switch assemblies 387, 1387, respectively, as shown in FIG. 5. Thus, bracket 1386 of switch assemblies 2387, 3387 is configured slightly differently than bracket 386 of switch assemblies 387, 1387 to accommodate the difference in spacing between upper and lower switches 390, 1390. This disclosure contemplates additional switch assembly embodiments covering every permutation of assembling brackets 386, 1386 and switches 390, 1390. In addition, switch assemblies having only one upper switch or one lower switch, as well as switch assemblies having only a pair of upper switches or a pair of lower switches are within the scope of this disclosure. Switch assemblies, such as illustrative switch assemblies 2387, 3387, having pairs of switches 390, 1390 are provided with connectors 1388 that are longer than connectors 388 to accommodate the additional electrical connections associated with the redundant switches 390, 1390.

Illustrative main valve modules 284, 1284, 2284, 3284, 4284 each have a different type of pipe connector configuration as shown in FIG. 5. Module 284 has a threaded pipe connection configuration with threads 422 as shown best in FIGS. 1 and 2. Pipes (not shown) that mate with module 284 have threaded end regions that threadedly engage threads 422. Module 1284 has a pair of flanges 424 with threaded couplers 426 that threadedly engage threads (not shown) of a valve body 1292 of module 1284 as shown in FIG. 5. Flanges 424 have a series of apertures 428 formed therein. Pipes (not shown) that mate with module 1284 have flanges (not shown) with apertures (not shown) that align with respective apertures 428 of flanges 424. Suitable couplers, such as bolts (not shown) are received by apertures 428 and by the apertures of the flanges of the associated pipes to couple module 1284 to the pipes. In some embodiments, gaskets or other suitable sealing materials are interposed between flanges 424 and the flanges of the pipes that couple to module 1284.

Module 2284 has a valve body 2292 and a pair of flanges 430 that are welded to valve body 2292. Flanges 430 are formed to include apertures 428, which are substantially similar to apertures 428 of flanges 424. Pipes (not shown) that mate with module 2284 couple to flanges 430 in substantially the same manner as described above with regard to the manner in which pipes couple to flanges 424. Module 3284 has a valve body 3292 and a pair of sockets 432 that are welded or otherwise coupled to valve body 3292. Pipes (not shown) that mate with module 3284 couple to the outer ends of sockets 432 via threads or other suitable couplers. Module 4284 has a valve body 4292 and a pair of flanged sockets 434 that are welded or otherwise coupled to valve body 4292. Flanged sockets 434 have flanges 436 at their respective outer ends which couple to flanges (not shown) of the pipes which mate with module 4284.

Controller 20 is included as one of the components of each of operators 286, 410 as mentioned above. Additional details of controller 20, as well as alternatives to controller 20, are shown in described in co-pending U.S. patent application Ser. No. _______ (attorney docket 3053-69517), which is titled PNEUMATIC EXHAUST CONTROLLER, and in co-pending U.S. patent application Ser. No. ______ (attorney docket 3053-69322), which is titled SHUT-OFF VALVE APPARATUS, both of these co-pending applications being filed concurrently herewith and both of these co-pending patent applications being hereby incorporated by reference herein.

As shown in FIGS. 6 and 7, solenoid valve 26 of controller 20 comprises a first body 56, a second body 58, and a separation disk 60 interposed between bodies 56, 58. Bodies 56, 58 and disk 60 are each formed to include a plunger-receiving bore 62. In addition, body 56 is formed to include a first passage 64 and a second passage 66. Each of passages 64, 66 communicates pneumatically with bore 62 of body 56. In addition, each of passages 64, 66 extends horizontally from bore 62 through body 56. Body 56 of solenoid valve 26 is mounted to a lower portion 32 of block 28 so that passage 64 formed in body 56 communicates pneumatically with a passage 50 formed in block 28 and so that passage 66 formed in body 56 communicates pneumatically with passage a 52 formed in block 28.

Solenoid valve 26 has a plunger 46, portions of which are situated within respective bores 62 of bodies 56, 58 and disk 60 as shown in FIG. 6. Solenoid valve 26 further comprises a spring 48 situated within bore 62 of body 56, a member or vent tube 68, and a vent cap 70. An annular end portion 72 of vent tube 68 is received in bore 62 of body 56. Spring 48 is maintained in a state of compression between end portion 72 of vent tube 68 and an annular shoulder portion 74 of plunger 46 as shown in FIG. 6. Disk 60 is fastened to body 56 with any suitable fastening means, such as, for example, adhesive, welding, bolts, pins, snaps, fingers, tabs or the like, to trap end portion 72 of vent tube 70 against body 56.

Vent tube 68 extends from body 56 through bore 62 of disk 60 and through bore 62 of body 58. Thus, vent tube 68 is supported in a cantilevered manner with respect to manifold 22. A cylindrical threaded portion 69 of vent tube 68 extends outwardly beyond an end surface 76 of body 58 and vent cap 70 threads onto the outwardly extending, distal end portion 69. The other portions of member 68 are cylindrical in some embodiments and have shapes other than cylindrical in alternative embodiments. For example, portions of member 68 may have square, rectangular, triangular, hexagonal, etc. cross sections. Vent cap 70 engages end surface 76 of body 58 to clamp body 58 against disk 60. An o-ring 77, shown in FIG. 6, is compressed radially between portion 72 of vent tube 68 and body 56. A first annular seal or gasket 79 is compressed axially between body 58 and disk 60 and a second seal or gasket 81 is compressed axially between body 58 and vent cap 70. O-ring 77 and the annular gaskets 79, 81 pneumatically seal the various interfaces between bodies 56, 58, disk 60, vent tube 68, and vent cap 70.

Vent tube 68 has a bore 84 in which a portion of plunger 46 is received as shown in FIG. 6 Vent tube 68 also has a vent passage 86 in pneumatic communication with bore 84 and a radially extending shoulder surface 88 extending between bore 84 and passage 86. Vent cap 70 has a vent chamber 90 in pneumatic communication with passage 86 of tube 68, an annular groove 92 formed in a hexagonal outer periphery 94, and a plurality of orifices 96 providing pneumatic communication between chamber 90 and groove 92. One or more cables 98 extend from body 58 of solenoid valve 26. Wires in cables 98 couple electrically to coil 44 to carry the electrical signals that energize and de-energize solenoid valve 26.

Plunger 46 is magnetized so that an electrical field created by coil 44 when solenoid valve 26 is energized moves plunger 46 against the bias of spring 48 from a first position, shown in FIG. 6, to a second position (not shown). When plunger 46 is in the first position, an end surface 100 of plunger 46 is biased by spring 48 into sealing engagement with an inner surface 110 of body 56 to block pneumatic communication between passage 64 and passage 66. When plunger 46 is in the second position, surface 100 is spaced apart from surface 110 and, in addition, an end surface 112 of plunger 46 is biased by the electrical field of energized coil 44 into sealing engagement with shoulder surface 88 of vent tube 68 to block pneumatic communication between bores 62, 84 and vent passage 86.

When plunger 46 is in the second position, pressurized air is able to move through portal 34, through passage 50 of block 28, through passage 64 of body 56, between end surface 100 of plunger 46 and inner surface 110 of body 56, through passage 66 of body 56, through passage 52 of block 28, and out of portal 40. Sealing engagement between end surface 112 of plunger 46 and shoulder surface 88 of vent tube 68 prevents the pressurized air from flowing through the space between plunger 46 and bore 84 of vent tube 68 and into vent passage 86. When plunger 46 is in the first position, pressurized air is able to vent to the ambient surroundings through portal 40, passage 52, passage 66, bores 62, bore 84, vent passage 86, cavity 90, and orifices 96.

Depending upon the environment or application in which valve assembly 280 is used, other types of solenoid coils, such as a hermetically sealed solenoid coil, may be required by safety regulations in lieu of illustrative solenoid coil 44 which is a general purpose coil. Solenoid coils having intermediate levels of sealing, such as those that are explosion proof or intrinsically safe, may also be required or desired. Body 58, coil 44, and seals 79, 81 are coupled together and are attachable to and detachable from member 68 as a unit (hereinafter referred to as “coil unit 44, 58, 79, 81”).

To replace coil unit 44, 58, 79, 81 with another coil unit having a different type of coil, vent cap 70 is unthreaded from member 68, coil unit 44, 58, 79, 81 is moved axially off of member 68, the new coil unit is placed on member 68, and cap 70 is threaded back onto member 68. Thus, solenoid valve 26 is configured to permit easy attachment and detachment of coil units as shown in FIG. 7 by phantom blocks 500, 502, 504, 506 which indicate 1−X types of solenoid coils. When cap 70 is decoupled from member 68 for removal and replacement of the coil unit, the other portions of controller 20 remain assembled together as shown in FIG. 7. Of course, during the initial assembly of solenoid valve 26, coil units are not interchanged, but rather, the desired type of coil unit is selected from the various types of coil units available and is mounted onto member 68. In the illustrative embodiment, solenoid valve 26 is, for example, a Series 8 solenoid valve available from Nass Magnet of Hanover, Germany. Suitable solenoid valves are available from other manufacturers as well.

As is evident from the above discussion, a number of different shut-off valve assemblies are assembled from various components, such as “short stroke” and “long stroke” operators 286, operator 410, switch assemblies 387, 1387, 2387, 3387 (with various configurations of switch sealing and/or redundancy), main valve modules 284, 1284, 2284, 3284, 4284 (with various configurations of pipe connectors), and with various types of coil units. In addition, modules 284, 1284, 2284, 3284, 4284 are available to mate with pipes of different sizes. In one example of a shut-off valve assembly product line according to this disclosure, modules 284, 1284, 2284, 3284, 4284 each are available in sizes that couple to pipes having the following diameters: 0.75″ (1.905 cm); 1″ (2.54 cm); 1.25″ (3.175 cm); 1.5″ (3.81 cm); 2″ (5.08 cm); 2.5″ (6.35 cm); 3″ (7.62 cm); 4″ (10.16 cm); and 6″ (15.24 cm). In this particular example, “short stroke” operator 286 is used with modules 284, 1284, 2284, 3284, 4284 that are sized for pipes of 3″ (7.62 cm) diameter or less; “long stroke” operator 286 is used with modules 284, 1284, 2284, 3284, 4284 that are sized for pipes ranging from 2.5″ (6.35 cm) to 4″ (10.16 cm); and operator 410 is used with modules 284, 1284, 2284, 3284, 4284 that are sized for pipes of 4″ (10.16 cm) and 6″ (15.24 cm). Thus, there is some overlap in the exemplary product line for some of the pipe diameters. In addition, coil springs 310 having different spring constants (i.e. force per unit length characteristics) may be included in each of modules 284, 1284, 2284, 3284, 4284. The higher the spring constant, the faster that the associated module 284, 1284, 3284, 4284 will move from the opened position to the closed position.

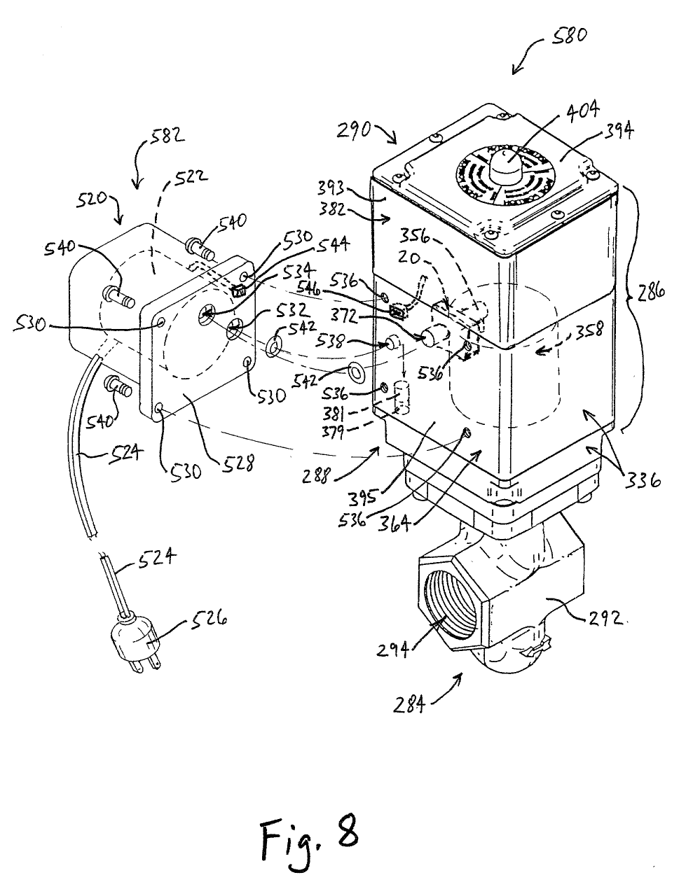

In some embodiments, the pressurized air that passes through controller 20 and that actuates the pneumatic actuator, such as actuator 282, of the associated shut-off valve assembly is “shop air” which is generated by pressurized air equipment of a facility and which supplied to the shut-off valve assembly via high pressure air lines routed through the facility. Some facilities do not have pressurized air equipment for generating shop air and other facilities do not have high pressure air lines routed to all of the locations throughout the facility having shut-off valve assemblies. According to this disclosure, an alternative embodiment shut-off valve assembly 580 has an air-delivery module 582 as shown in FIG. 8.

Illustratively, shut-off valve assembly 580 has many of the same components as shut-off valve assembly 280. However, the following description of the use of air-delivery module 582 with shut-off valve assembly 580 is applicable to all of the shut-off valve embodiments described herein. As shown in FIG. 8, assembly 580 comprises main valve module 282 and operator 286 which, in turn, comprises pneumatics module 288 and electronics module 290. The main difference between assembly 580 and assembly 280 is the configuration of upper piece 364 of housing 336 of pneumatics module.

Air-delivery module 582 has a housing 520 that is configured with an interior region that receives a pressure source 522, shown in FIG. 8 (in phantom). Pressure source 522 comprises any device, such as a pump or a compressor, that is capable of producing a suitable amount of pressure for actuating actuator 282 of operator 286. Module 582 has appropriate couplers and/or brackets (not shown) which mount pressure source 522 to housing 520. In some embodiments, interior region of housing 520 is lined or filled with insulation or padding to attenuate the noise produced by pressure source 520 when operating.

Module 582 has an electrical cord 524 that extends from pressure source 522 out of housing 520 and that terminates at an electrical plug 526 which mates with a standard electrical outlet (not shown) to provide electrical power to pressure source 522. Housing 520 has a square-shaped flange 528, each corner region of flange 528 being formed to include an aperture 530. Flange 528 is also formed to include an inlet aperture 532 and an outlet aperture 534. A set of threaded apertures 536 are tapped into piece 364 on the same wall of piece 364 that has opening 372 formed therein. In addition to opening 372, which communicates with portal 34 of controller 20, piece 364 has an opening 538 that communicates with interior region 371 of module 288.

A set of screws 540 are provided for mounting module 582 to operator 286. Each screw 540 extends through a respective aperture 530 formed in flange 528 and threadedly engages a respective threaded aperture 536 formed in piece 364 of housing 336. Thus, when module 582 is mounted to operator 286, flange 528 abuts the surface 395 of piece 364 having openings 372, 538. Aperture 532 of flange 528 is aligned with and communicates pneumatically with opening 538 when module 582 is mounted to operator 286. Similarly, aperture 534 of flange 528 aligns with and communicates pneumatically with opening 372 when module 582 is mounted to operator 286. A pair of o-rings 542 are interposed between flange 528 and piece 364 to pneumatically seal the interface between openings 372, 538 and apertures 534, 532, respectively. Apertures 532, 534 have recessed or countersunk portions that receive portions of o-rings 542 to prevent 0-rings 532, 534 from moving out of proper alignment with respective openings 372, 538 and apertures 532, 534.

Module 582 has an electrical connector 544 coupled to flange 528 and operator 286 has an electrical connector 546 coupled to piece 364 of housing 336. When module 522 is mounted to operator 286, connector 544 mates with connector 546 automatically. To actuate pneumatic actuator 282 of module 286, an electrical control signal is provided to pressure source 522 through connectors 544, 546 and the associated wiring. The control signal to operate pressure source 522 is one of the electrical signals that is received by connector 388 of electronics module 290. In addition, the control signal to operate pressure source 522 is sent substantially simultaneously with the signal that energizes solenoid valve 26 of controller 20.

When pressure source 522 receives the appropriate control signal, pressure source 522 operates to deliver pressurized air to space 358 through aperture 534, opening 372, controller 20, and passage 356. Receipt of pressurized air in space 358 moves piston 344 downwardly, thereby moving module 284 from the closed position to the opened position. The air which is pressurized by pressure source 522 is received from interior region 371 of housing 336 through opening 538 and aperture 532. As mentioned above, interior region 371 communicates with the ambient environment through passage 379 in which filter 381 is situated. Thus, as pressure source 522 draws air from interior region 371, ambient air moves into interior region 371 through passage 379 and filter 381. In alternative embodiments, pressure source 522 receives air through an opening and/or filter (not shown) formed in portions of housing 520 other than flange 528.

The rate at which pressure source 522 delivers pressurized air to space 358 determines how quickly module 284 moves from the closed position to the opened position. If pressure source 522 has a relatively low capacity, then module 284 may open relatively slowly. However, in many applications the speed at which module 284 opens is not of primary concern, so long as module closes quickly in an emergency situation, for example. As described above, controller 20 is configured to exhaust air rapidly from space 358 when solenoid 26 is de-energized so that module 284 closes quickly. Therefore, use of module 522 to deliver pressurized air to operator 286, rather than using high pressure “shop air,” does not affect the closing speed of module 284.

In applications where it is desirable to open module 284 quickly, then an alternative air-delivery module may be provided. In such an alternative air-delivery module, pressure source 522 operates to pressurize the interior region of housing 520. When solenoid 26 is energized, the pressurized air from the interior region of housing 520 moves through aperture 534, opening 372, controller 20, passage 356 and into space 358 to actuate actuator 282. Thus, in the alternative air-delivery module, housing 520 serves as a pressure reservoir. In some embodiments, cord 524 and plug 526 are omitted and pressure source 522 receives electrical power via connectors 544, 546 and the associated wiring. In other embodiments, one or more control switches (not shown) that control the operation of pressure source 522 and/or solenoid valve 26 are mounted to either housing 520 of module 582 or to operator 286.

Although certain illustrative embodiments have been described in detail above, variations and modifications exist within the scope and spirit of this disclosure as described and as defined in the following claims.

1. A valve apparatus for use with a source of pressurized air, the valve apparatus comprising
a main valve module having a valve body and a valve member coupled to the valve body, the valve member being movable between a first position blocking material flow through the valve body and a second position permitting material flow through the valve body, and
an operator coupled to the main valve module, the operator having a pneumatics module and an electronics module, the pneumatics module having a pneumatic actuator that, when actuated, moves the valve member from the first position to the second position, the pneumatic actuator being coupled to the source of pressurized air, the pneumatics module having an electrical actuator that, when energized, permits pressurized air from the source of pressurized air to reach the pneumatic actuator to actuate the pneumatic actuator, the electronics module having an electrical connector and at least one conductor that electrically couples the connector to the electrical actuator, the pneumatics module being situated between the electronics module and the main valve module.

2. The valve apparatus of claim 1, wherein the pneumatics module has a first housing in which the pneumatic actuator is situated, the electronics module has a second housing in which the electrical connector is situated, and the second housing is coupled to the first housing.

3. The valve apparatus of claim 2, wherein the first housing has a first set of side walls, the second housing has a second set of side walls, and each side wall of the first set of side walls has an external surface that is substantially coplanar with a corresponding external surface of the second set of side walls.

4. The valve apparatus of claim 2, wherein the electrical actuator is situated in the first housing.

5. The valve apparatus of claim 1, wherein the main valve module is adapted to couple to pipes of a piping system and the operator is decouplable from the main valve module while the main valve module remains coupled to the pipes of the piping system.

6. The valve apparatus of claim 1, wherein the main valve module is adapted to couple to pipes of a piping system and the electronics module is decouplable from the pneumatics module while the main valve module remains coupled to the pipes of the piping system, while the pneumatics module remains coupled to the main valve module, and while the source of pressurized air remains coupled to the pneumatics module.

7. A valve apparatus for use in a piping system having a first pipe and a second pipe through which material flows, the valve apparatus comprising
a main valve module having a valve body coupled to the first and second pipes, the valve module having a valve member movable relative to the valve body between a first position blocking material flow through the valve body and a second position permitting material flow through the valve body,
a pneumatics module coupled to the main valve module and having a pneumatic actuator that receives pressurized air from a pressurized air source to move the valve member from the first position to the second position, the pneumatics module having an electrical actuator that operates to selectively block and unblock delivery of pressurized air to the pneumatic actuator, the pneumatics module being decouplable from the main valve module while the valve body remains coupled to the first and second pipes, and
an electronics module coupled to the pneumatics module, the electronics module having an electrical connector and at least one conductor that electrically couples the connector to the electrical actuator, the electronics module being decouplable from the pneumatics module while the main valve module remains coupled to the pipes of the piping system, while the pneumatics module remains coupled to the main valve module, and while the source of pressurized air remains coupled to the pneumatics module.

8. The valve apparatus of claim 7, wherein the pneumatics module has a first housing in which the pneumatic actuator is situated, the electronics module has a second housing in which the electrical connector is situated, and the second housing is coupled to the first housing.

9. The valve apparatus of claim 8, wherein the first housing has a first set of side walls, the second housing has a second set of side walls, and each side wall of the first set of side walls has an external surface that is substantially coplanar with a corresponding external surface of the second set of side walls.

10. The valve apparatus of claim 8, wherein the electrical actuator is situated in the first housing.

11. The valve apparatus of claim 7, wherein the electronics module has a sensor configured to sense whether the valve member is in the first position.

12. The valve apparatus of claim 11, wherein the sensor is a switch that is engaged by a portion of the pneumatic actuator when the valve member is in the first position.

13. The valve apparatus of claim 12, wherein the electrical actuator comprises a solenoid having a solenoid coil, the solenoid coil is hermetically sealed, and the switch is hermetically sealed.

14. The valve apparatus of claim 12, wherein the electronics module has a bracket, the switch is coupled to the bracket, and the connector is coupled to the bracket.

15. A valve apparatus comprising
a main valve module having a valve body and a valve member coupled to the valve body, the valve member being movable between a first position blocking material flow through the valve body and a second position permitting material flow through the valve body,
an operator coupled to the main valve module, the operator having a pneumatic actuator that, when actuated, moves the valve member from the first position to the second position, and
an air-delivery module coupled to the actuator module, the air-delivery module having a pressure source that is operably coupled to the pneumatic actuator, the pneumatic actuator being actuated by pressurized air received from the pressure source.

16. The valve apparatus of claim 15, wherein the actuator module has a first housing, the air-delivery module has a second housing connected to the first housing, the second housing having an interior region, and the pressure source is situated in the interior region.

17. The valve apparatus of claim 16, wherein the pressure source is an electric pump.

18. The valve apparatus of claim 17, wherein the air-delivery module comprises an electrical cord coupled to the electric pump and extending from the second housing.

19. The valve apparatus of claim 16, wherein the pressure source is an electric compressor.

20. The valve apparatus of claim 19, wherein the air-delivery module comprises an electrical cord coupled to the electric pump and extending from the second housing.
